(19) United States
(12) Patent Application Publication
(10) Pub. No.: US 2009/0158353 A1
(43) Pub. Date: Jun. 18, 2009

(54) System and method for user-customized type media service based on single-media multi-devices

(75) Inventors: Ki-Sook Chung, Daeleon (KR); Hae Ryong Lee, Daejeon (KR); Kwang Roh Park, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/155,945

(22) Filed: Jun. 11, 2008

(30) Foreign Application Priority Data
Dec. 15, 2007 (KR) 10-2007-0131817

(51) Int. Cl. H04N 7/173

(52) U.S. Cl. 725/59

(57) ABSTRACT

A system for user customized media service based on single-media multi-devices (SMMD), which cooperatively controls devices in accordance with effect information when media are reproduced, includes menu providing means for providing a setting menu capable of setting or correcting the effect information; and managing means for setting or correcting a device profile having information for cooperation with the devices in accordance with the setting or correcting the effect information. The system further includes controlling means for controlling the devices in accordance with the effect information. The method for user customized media service based on SMMD includes providing a setting menu capable of setting or correcting the effect information; setting or correcting a device profile having information for cooperation of the devices on a basis of the set or corrected effect information; and cooperatively controlling the devices in accordance with the effect information for the device profile.

### CROSS-REFERENCE(S) TO RELATED APPLICATIONS

The present invention claims priority of Korean Patent Application No. 10-2007-0131817, filed on Dec. 15, 2007, which is incorporated herein by reference.

### FIELD OF THE INVENTION

The present invention relates to presenting user-customized media based on single-media multi-device (SMMD); and, more particularly, to a system and method for a user customized media service based on the SMMD, which presents ne-media including device control signals.

### BACKGROUND OF THE INVENTION

A Single-media multi-device (SMMD)-based media service is such a service that, when reproducing media, controls various devices around a user to transmit realistic effects of the media to the user, thereby maximizing media effects.

For implementing such an SMMD-based media service, the media need a new format to provide information for interworking with the devices around the user. Such new media are called “ne-media” or “ne-content”, where the prefix “ne” refers to “any” in view of pronunciation and “new”, “neo”, “next”, etc. in view of meaning. The ne-media are defined as a structure of embracing existing media and including information for controlling devices in accordance with a sequence of media after defining the devices to interact with the media based on a content of the media. In other words, the structure of the ne-media embraces the existing media having audio, video and text, without change, and neo-data include the information about devices to interact with the existing media in accordance with the content of the existing media. Further, a parameter control signal for each device is inserted with being synchronized with the media. That is, the ne-media include information about effects in addition to information about scenes of the media, and thus, when one of the ne-media is reproduced, the peripheral devices are cooperatively controlled in order to implement the effect information included in the media.

A system of reproducing such ne-media has an interface storing and controlling information about the peripheral devices, analyzes the effect information included in the media to search for a proper peripheral device, and controls the peripheral device in synchronization with the reproduction of the media, so that the content of the media is more effectively transmitted to the user.

The SMMD based media service is such a service that maximizes media effects in cooperation with at least one device around the user, and thus allows the user to feel as though the user were a hero (or heroine) in the media. To this end, a system for providing the SMMD based media service must include functions of analyzing the effect information included in the media, and of automatically controlling the peripheral devices.

Thus, given are a project for developing technologies associated with the analysis of the effect information of the media and the control of the devices, and, particularly, a prerequisite project to solve a problem of satisfying a variety of users since every user has his taste or preference.

### SUMMARY OF THE INVENTION

It is, therefore, an object of the present invention to enable a user to set a reproduction environment and adjust a level of effect presentation so as to be suitable for his or her own taste or preference when single-media multi-device (SMMD)-based media are reproduced, so that user customized effect can be controlled.

In accordance with one aspect of the present invention, there is provided a system for user customized media service based on single-media multi-devices (SMMD), which cooperatively controls one or more devices in accordance with effect information when media are reproduced, the system including menu providing means for providing a setting menu capable of setting or correcting the effect information; managing means for setting or correcting a device profile having information for cooperation with the devices in accordance with the setting or correcting the effect information through the setting menu; and controlling means for cooperatively controlling the devices in accordance with the effect information for the device profile when the media are reproduced.

The controlling means may include synchronization controlling means for generating an instruction corresponding to the effect information for the device profile in order to control all the devices with being synchronized to each other when the media are reproduced; and device controlling means for cooperatively controlling the devices in accordance with the instructions when the media are reproduced.

Further, the managing means may store as effect setting data the set or corrected effect information which is set or corrected through the setting menu, and applies the effect setting data to the device profile.

It is preferable that one of the effect setting data and the device profile includes a device identifier which is information about the devices, an effect type that can be represented for the device identifier, and an effect level value which is information on intensity for each effect type.

The effect type may have at least one piece of information.

Further, a value of the effect level may be represented in percentage (%) units.

Preferably, one of the effect setting data and the device profile includes operation information representing instructions for operation of the devices.

Further, preferably, one of the effect setting data and the device profile includes an effect set identifier, which is an identifier for a set of effects in which the value of the effect level is set for each effect type.

In accordance with another aspect of the invention, there is provided a method for user customized media service based on single-media multi-devices (SMMD), which cooperatively controls one or more devices in accordance with effect information when media are reproduced, the method including providing a setting menu capable of setting or correcting the effect information; setting or correcting a device profile having information for cooperation of the devices on a basis of the setting or correcting the effect information through the setting menu; and cooperatively controlling the devices in accordance with the effect information for the device profile when the media are reproduced.

The setting or correcting may include storing as effect information data the set or corrected effect information which is set or corrected through the setting menu; and setting or correcting the device profile on a basis of the effect information data.

Preferably, one of the storing the set or corrected effect information, and the setting or correcting the device profile performs setting or correcting an effect level value, which indicates information on intensity for each effect type that can be represented for the devices.

Further, preferably, one of the storing the set or corrected effect information, and the setting or correcting the device profile performs setting or correcting an effect set identifier, which is an identifier for a set of effects in which the effect level value is set for each effect type.

In accordance with the present invention, the effect information for the cooperation of the devices is set or updated in the SMMD based media service, and particularly, the effect level value is set to control the intensity depending on the effect type, so that the user customized media service is possible, and thus the media effects are maximized.

Further, the effect level value can be designated depending on the effect type of the media, so that, despite that types of peripheral devices are changed, the user can conveniently designate the device effects.

In addition, the profile for the effect information is separately stored and managed, so that a variety of settings in accordance with environmental factors, such as age and taste of the user, and a season are possible, thus improving the convenience of the user.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating a system for user customized media service based on single-media multi-devices (SMMD) in accordance with the present invention;

FIG. 2 illustrates a data structure of a device profile in accordance with an embodiment of the present invention;

FIG. 3 illustrates a data structure of a device profile in accordance with an embodiment of the present invention and refers to a detailed device profile including effect information;

FIG. 4 illustrates a data structure of an effect setting data in accordance with an embodiment of the present invention;

FIG. 5 is a flow chart explaining a method for user customized media service based on SMMD, and illustrates a procedure of setting a device effect level and of storing the set result in a device profile; and

FIG. 6 is a flow chart explaining a method for user customized media service based on SMMD, and illustrates a procedure of searching for user customized effects when the media are reproduced, and of controlling each device.

### DETAILED DESCRIPTION OF THE EMBODIMENTS

Hereinafter, embodiments of the present invention will be described in detail with reference to the accompanying drawings so that they can be readily implemented by those skilled in the art. The detailed descriptions of known functions and constructions that unnecessarily obscure the subject matter of the present invention will be avoided herein.

The present invention can provide user customized media service based on single-media multi-devices (SMMD) in a manner such that, when a user presents information about each effect, an interface capable of controlling a level the presented information is provided, the controlled information is stored in cooperation with a device profile, and then devices are properly controlled.

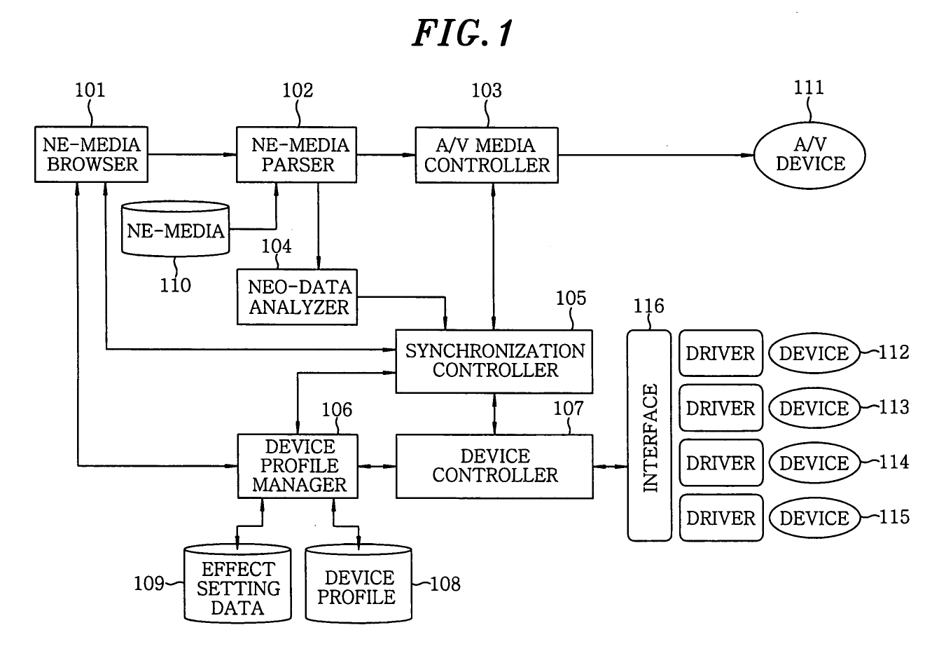

FIG. 1 is a block diagram illustrating a system for user customized media service based on single-media multi-devices (SMMD).

Referring to FIG. 1, the media service system of the present invention comprises menu providing means such as an ne-media browser 101; an ne-media parser 102; an audio/video (A/V) media controller 103; a neo-data analyzer 104; synchronization controlling means such as a synchronization controller 105; managing means such as a device profile manager 106; and device controlling means such as a device controller 107.

The ne-media browser 101 provides an interface for using the SMMD based media service or for user setting, and receives an instruction from a user to direct controls of media and a device.

The ne-media parser 102 parses ne-media 110 when the user selects media through the ne-media browser 101. Effect information, i.e. neo-data, included in the ne-media is transmitted to the neo-data analyzer 104. And an A/V stream is transmitted to the A/V media controller 103, is decoded and is outputted to an A/V device 111.

When the user sets or corrects the effect information through the ne-media browser 101, the device profile manager 106 stores the effect information as effect setting data 109, and searches for devices 112, 113, 114 and 115 corresponding to the respective effects, to thereby be applied to a corresponding device profile 108.

The synchronization controller 105 generates and transmits instructions for controlling the A/V media controller 103 and the device controller 107 such that all of the devices can be synchronized with each other, with reference to the device profiles, while the media are reproduced.

The device controller 107 generates an instruction in accordance with a hardware interface of each of the devices 112, 113, 114 and 115, transmits each instruction to a corresponding interface 116, and maximizes the effects of the media in cooperation with the devices 112, 113, 114 and 115.

In the embodiment of FIG. 1, the synchronization controller 105 and the device controller 107 are separately implemented. Alternatively, they may be implemented as a single control means for cooperatively controlling the devices 112, 113, 114 and 115 on the basis of the effect information using the device profile when the ne-media 110 is reproduced.

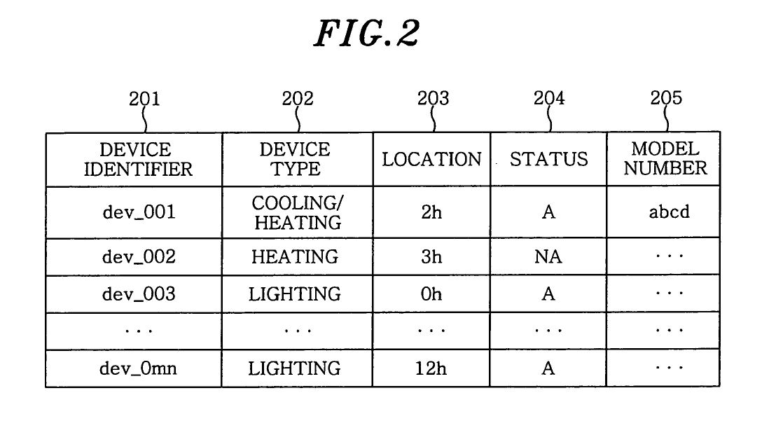

FIG. 2 illustrates a data structure of a device profile 108 in accordance with an embodiment of the present invention.

Referring to FIG. 2, the device profile 108 is information about the respective devices to allow the media effects to be realized by controlling the devices, and includes a device identifier 201, a device type 202, a location 203, a device status 204, and a device model number 205.

The device identifier 201 is each device's own identifier recognized by the media service system, and the device type 202 refers to types of devices based on typical classification. The location 203 presents a location of each device relative to the user in a visible form so as to be able to properly exhibit the media effects, and the device status 204 indicates statuses of the devices connected to the system thereby indicating a connection and an operation status of the devices. The device model number 205 refers to the product model of each device.

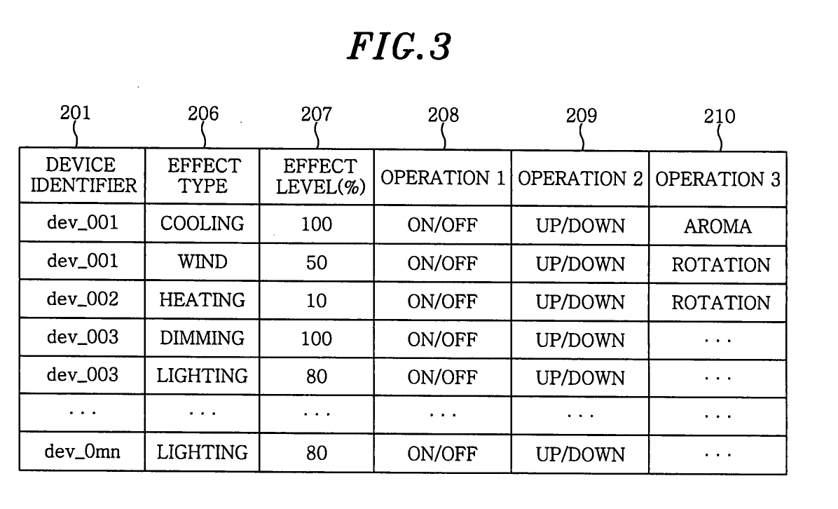

FIG. 3 illustrates a data structure of the device profile 108 in accordance with an embodiment of the present invention and refers a detailed device profile including effect information.

Referring to FIG. 3, the device profile 108 includes an effect type 206 and an effect level 207 for each device identifier 201. Although the number of information of effect type 206 for the device identifier 201 is illustrated as one in FIG. 3, however, that is no more than an example and the number may be greater than one. For example, one device can present a wind effect and a cooling effect. The effect level 207 indicates intensity information that the user prefers with respect to the effect type 206. Since the effect level 207 is represented in percentage (%) units, when the media are reproduced, the user can obtain the device effect with wanted intensity. A first operation 208, a second operation 209, and a third operation 210 represent instructions for operations of the devices, and can define the operation information for each device and effect.

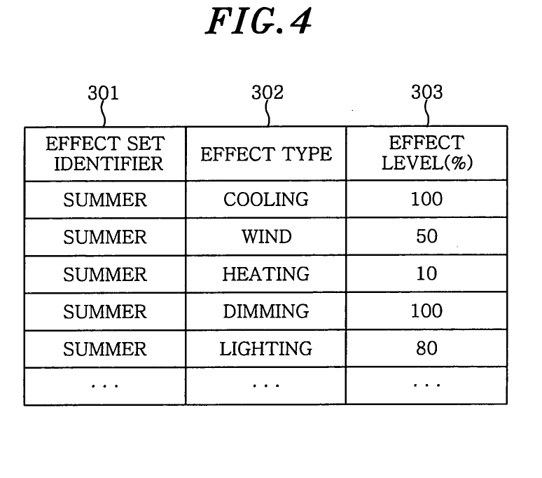

FIG. 4 illustrates a data structure of the effect setting data 109 in accordance with an embodiment of the present invention. The effect setting data 109 stores the effect information set by the user so as to be able to provide user customized effect information, and includes an effect set identifier 301, an effect type 302, and an effect level 303. The effect set identifier 301 is an identifier of an effect set in which the effect level 303 is set for each effect type 302. For example, the effect level 303 preferred in summer is designated by cooling 100%, wind 50%, heating 10%, etc., and is stored with the identifier “summer.” The device profile manager 106 receives this information from the user through the user interface provided by the ne-media browser 101, stores the effect setting data 109 corresponding thereto, and corrects the device profile 108 corresponding to the related effects, whereby, when the media are reproduced, each device is controlled at the level that the user wants. This effect level data can be stored depending on the season, the age of the user, and the gender of the user, respectively, and thereby can be selectively applied when the media are reproduced.

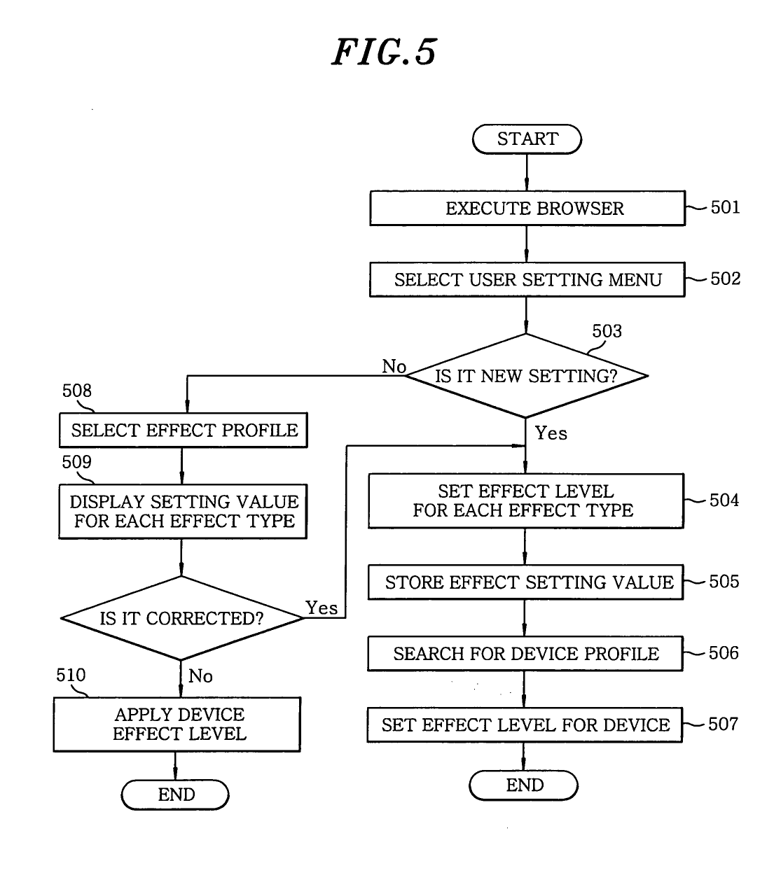

FIG. 5 is a flow chart explaining a method for providing user customized media service based on SMMD, and illustrates a procedure of setting a device effect level and storing them in a device profile.

First, when the ne-media browser 101 is executed (S501), a user setting menu is provided. Then, a user can select an item in the provided user setting menu (S502) to thereby set user customized device effects.

When the user wants to set a new effect level (S503), the user sets the effect level for each effect type through the user setting menu (S504). In this case, the effect type can be divided into a cooling effect, a heating effect, a wind effect, an aroma effect, a vibration effect, a lighting effect, a dimming effect, and so on, for each of which the effect level desired by the user is inputted in percentage (%) units.

The user setting information, inputted that way, is transmitted to the device profile manager 106. The device profile manager 106 stores the effect setting data 109 on the basis of the received user setting information (S505). In other words, the effect level 303 for each effect type 302 as in FIG. 4 is stored. Here, when it comes to setting the effect level 303 for each effect type 302, the effect set identifier 301 of FIG. 4 can be used. For example, the user setting information is merely applied to the “summer” environment using the identifier “summer” in step S504, which can be selected when the media are reproduced.

The device profile manager 106 stores the effect setting data 109, and then searches for the device profile 108 (S506). Thus, the device profile manager 106 finds a device capable of representing the user customized effect stored in step S505, and applies the value of the effect level to the device (S507). In other words, the effect type 206 and the effect level 207 of FIG. 3 are updated on the basis of the effect type 302 and the effect level 303 of FIG. 4, so that each device is controlled at the level that the user wants when the media are reproduced.

When the user does not want to set the new effect level in step S503, the user can select a pre-stored effect profile through the user setting menu (S508). In this case, the device profile manager 106 loads the pre-stored effect setting data 109, and transmits this to the ne-media browser 101. The ne-media browser 101 displays a set value of the effect level for each effect type on the basis of the effect setting data 109 (S509).

When the user corrects the pre-stored effect setting data 109 in step S509, the aforementioned steps S504 to S507 are performed. In contrast, when the user does not correct the pre-stored effect setting data 109, the effect level of each device is applied on the basis of the pre-stored effect setting data 109 when the media are reproduced (S510). Thereby, each of the devices 112, 113, 114 and 115 is controlled at the level desired by the user.

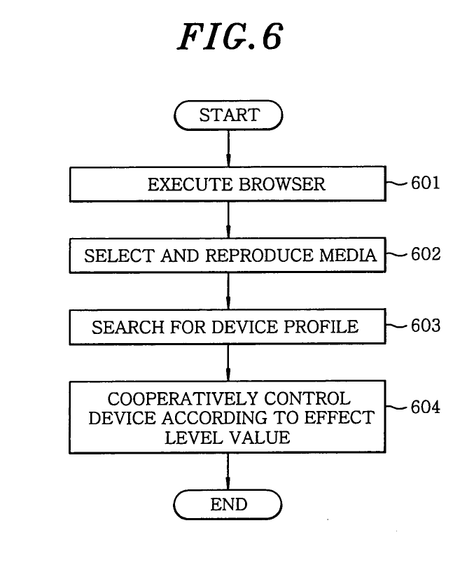

FIG. 6 is a flow chart explaining a method for user customized media service based on SMMD, and illustrates a procedure of searching for user customized effects when the media are reproduced, and of controlling each device.

In the case of reproducing the ne-media 110, the ne-media browser 101 is also executed (S601), and thus the ne-media 110 is selected and reproduced (S602).

Then, in order to map and control the devices based on effect information of the ne-media 110 provided from the neo-data analyzer 104, the synchronization controller 105 searches for a corresponding device profile through the device profile manager 106 (S603).

Thereby, the synchronization controller 105 loads the device profile 108, corresponding to the user customized effects, described above with reference to FIG. 5, and cooperatively controls the device controller 107 such that the effects of the devices 112, 113, 114 and 115 are controlled using the value of the effect level in accordance with the effect type of the device profile 108 (S604).

While the invention has been shown and described with respect to the embodiments, it will be understood by those skilled in the art that various changes and modifications may be made without departing from the scope of the invention as defined in the following claims.

1. A system for user customized media service based on single-media multi-devices (SMMD), which cooperatively controls one or more devices in accordance with effect information when media are reproduced, the system comprising:
menu providing means for providing a setting menu capable of setting or correcting the effect information;
managing means for setting or correcting a device profile having information for cooperation with the devices in accordance with the setting or correcting the effect information through the setting menu; and
controlling means for cooperatively controlling the devices in accordance with the effect information for the device profile when the media are reproduced.

2. The system of claim 1, wherein the controlling means includes:
synchronization controlling means for generating an instruction corresponding to the effect information for the device profile in order to control all the devices with being synchronized to each other when the media are reproduced; and
device controlling means for cooperatively controlling the devices in accordance with the instructions when the media are reproduced.

3. The system of claim 1, wherein the managing means stores as effect setting data the set or corrected effect information which is set or corrected through the setting menu, and applies the effect setting data to the device profile.

4. The system of claim 3, wherein one of the effect setting data and the device profile includes a device identifier which is information about the devices, an effect type that can be represented for the device identifier, and an effect level value which is information on intensity for each effect type.

5. The system of claim 4, wherein the effect type is has at least one piece of information.

6. The system of claim 4, wherein a value of the effect level is represented in percentage (%) units.

7. The system of claim 4, wherein one of the effect setting data and the device profile includes operation information representing instructions for operation of the devices.

8. The system of claim 4, wherein one of the effect setting data and the device profile includes an effect set identifier, which is an identifier for a set of effects in which the value of the effect level is set for each effect type.

9. A method for user customized media service based on single-media multi-devices (SMMD), which cooperatively controls one or more devices in accordance with effect information when media are reproduced, the method comprising:
providing a setting menu capable of setting or correcting the effect information;
setting or correcting a device profile having information for cooperation of the devices on a basis of the setting or correcting the effect information through the setting menu; and
cooperatively controlling the devices in accordance with the effect information for the device profile when the media are reproduced.

10. The method of claim 9, wherein the setting or correcting includes:
storing as effect information data the set or corrected effect information which is set or corrected through the setting menu; and
setting or correcting the device profile on a basis of the effect information data.

11. The method of claim 10, wherein one of the storing the set or corrected effect information, and the setting or correcting the device profile performs setting or correcting an effect level value, which indicates information on intensity for each effect type that can be represented for the devices.

12. The method of claim 11, wherein one of the storing the set or corrected effect information, and the setting or correcting the device profile performs setting or correcting an effect set identifier, which is an identifier for a set of effects in which the effect level value is set for each effect type.

13. A system for user customized media service based on single-media multi-devices (SMMD), which cooperatively controls one or more devices in accordance with effect information when media are reproduced, the system comprising:
menu provider provide a setting menu capable of setting or correcting the effect information;
manager to or correct a device profile having information for cooperation with the devices in accordance with the setting or correcting the effect information through the setting menu; and
controller to cooperatively control the devices in accordance with the effect information for the device profile when the media are reproduced.

14. The system of claim 13, wherein the controller includes:
synchronization controller to generate an instruction corresponding to the effect information for the device profile to control all the devices with being synchronized to each other when the media are reproduced; and
device controller to cooperatively control the devices in accordance with the instructions when the media are reproduced.

15. The system of claim 13, wherein the manager to store as effect setting data the set or corrected effect information which is set or corrected through the setting menu, and to apply the effect setting data to the device profile.

16. The system of claim 15, wherein one of the effect setting data and the device profile includes a device identifier which is information about the devices, an effect type that can be represented for the device identifier, and an effect level value which is information on intensity for each effect type.

17. The system of claim 16, wherein the effect type is has at least one piece of information.

18. The system of claim 16, wherein a value of the effect level is represented in percentage (%) units.

19. The system of claim 16, wherein one of the effect setting data and the device profile includes operation information representing instructions for operation of the devices.

20. The system of claim 16, wherein one of the effect setting data and the device profile includes an effect set identifier, which is an identifier for a set of effects in which the value of the effect level is set for each effect type.
